(19) United States
(12) Patent Application Publication
(10) Pub. No.: US 2015/0143294 A1
(43) Pub. Date: May 21, 2015

(54) SYSTEM AND METHOD FOR PRESENTING A RESPONSIVE MULTI-LAYERED ORDERED SET OF ELEMENTS

(71) Applicant: UpTo, Inc., Detroit, MI (US)

(72) Inventors: Mathew Piccinato, Pleasant Ridge, MI (US); Gregory Schwartz, Birmingham, MI (US); Christopher Kaufman, Huntington Woods, MI (US); David Webber, Farmington hills, MI (US); Jesse Hendrickson, Detroit, MI (US)

(21) Appl. No.: 14/549,255

(22) Filed: Nov. 20, 2014

Related U.S. Application Data
(60) Provisional application No. 61/907,176, filed on Nov. 21, 2013.

(51) Int. Cl. G06F 3/0482; G06F 3/0488; G06F 3/0485

(52) U.S. Cl. CPC G06F 3/0482; G06F 3/0485; G06F 3/0488
USPC 715/817

(57) ABSTRACT

A system and method for presenting a scrollable-list interface comprising defining an ordered set of elements which includes elements classified into at least two layers; rendering a set of first layer elements of the ordered set in a navigable interface, the set of first layer elements ordered according to the ordered set; rendering a condensed indicator element associated with at least one element classified in a second layer in the navigable interface, the condensed indicator element ordered within the set of first layer elements according to the ordered set; receiving a user input to the navigable interface; and augmenting a layered representation of the ordered set in the navigable interface, wherein the layered representation is augmented in accordance with the user input.

### CROSS-REFERENCE TO RELATED APPLICATIONS

This application claims the benefit of U.S. Provisional Application Ser. No. 61/907,176, filed on 21-Nov.-2013, which is incorporated in its entirety by this reference.

### TECHNICAL FIELD

This invention relates generally to the user interface field, and more specifically to a new and useful system and method for presenting a responsive multi-layered ordered set of elements in the user interface field.

### BACKGROUND

Content streams have become a common format for navigating ordered sets of information. For time-based events, such content streams are often time ordered scrollable lists of information. They can be encountered when interacting with event based applications such as in calendars and social media content streams. However, when digesting information from such scrollable lists, the amount of information can be overwhelming—to such an extent that important information can be lost in the noise of other information. Thus, there is a need in the user interface field to create a new and useful system and method for presenting a responsive multi-layered ordered set of elements. This invention provides such a new and useful system and method.

### BRIEF DESCRIPTION OF THE FIGURES

FIG. 1 is a flowchart representation of a method of a preferred embodiment;

FIG. 2 is a table representation of an exemplary set of information used in the method;

FIG. 3 is an exemplary screenshot representation of presenting multiple layers;

FIG. 4 is an exemplary screenshot representation of representing a layer of items and condensed indicators of second layer items;

FIG. 5 is a schematic representation of detecting a revealing input;

FIG. 6 is a schematic representation of detecting a collapsing input;

FIG. 7 is an exemplary screenshot representation of animating change in presentation of the items;

FIGS. 8 and 9 are schematic representations of variations in migrating an item to a new layer;

FIG. 10 is a schematic representation of a system of a preferred embodiment;

FIG. 11 is a schematic representation of a variation of scrolling the navigable interface;

FIG. 12 is a schematic representation of a variation of re-classifying an element within the navigable interface.

### DESCRIPTION OF THE PREFERRED EMBODIMENTS

The following description of preferred embodiments of the invention is not intended to limit the invention to these preferred embodiments, but rather to enable any person skilled in the art to make and use this invention.

### 1. Method for Presenting a Multi-Layered Ordered Set

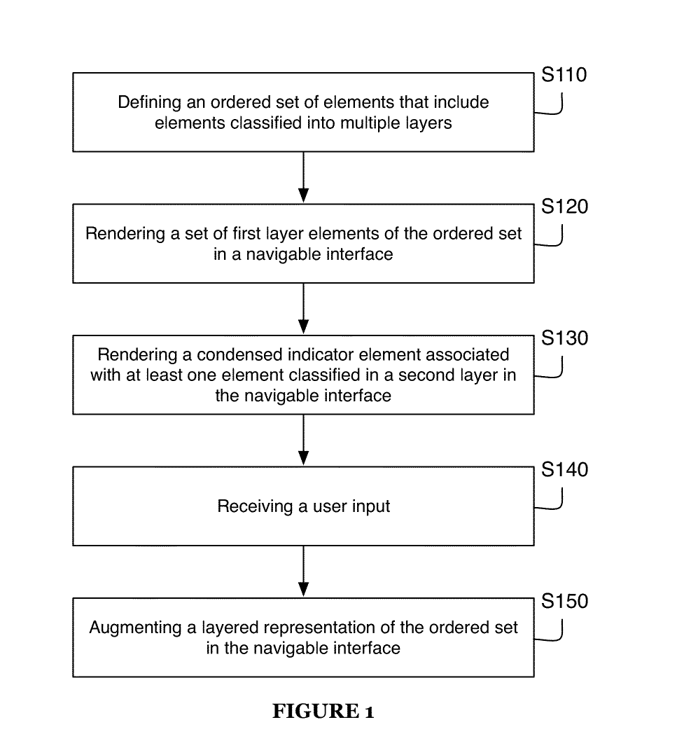

As shown in FIG. 1, a method for presenting a responsive multi-layered ordered set of information of a preferred embodiment can include defining an ordered set of elements that include elements classified into multiple layers S110, rendering a set of first layer elements of the ordered set in a navigable interface S120, rendering a condensed indicator element associated with at least one element classified in a second layer in the navigable interface S130, receiving a user input S140; and augmenting a layered representation of the ordered set in the navigable interface S150. The method can be applied towards expanding the number of layers presented in the navigable interface (i.e., “revealing”) and/or towards restricting the number of layers presented in the navigable interface (i.e., “collapsing”). The method functions to provide an intuitive and non-intrusive user interface for parsing, filtering, and digesting large amounts of information. In a preferred implementation, the method is applied towards switching between a focused view of a data-set (e.g., presenting only relevant information) and an expanded view of the data set (e.g., presenting the full set of information). In other variations, the method can be applied to switching from a focused view to a first expanded view of the data set to a third expanded view of the data set, and onto any suitable number of expanded views. The method is preferably implemented within a touch screen interface but can alternatively be applied to a computing devices responsive to a keyboard, mouse, motion, voice activated commands, or other suitable form of input. In a preferred implementation, a list of items is presented in a scrollable view on a touch device. The immediately presented items are items of a top priority layer. Where items of a lower-tier layer would be presented if fully represented, there are preferably thin bars to communicate the presence of a hidden layer. If the user provides a layer-reveal user input (e.g., a spreading gesture input) to the device, the hidden items are visibly revealed as the user spreads their fingers. Completing the layer-reveal user input, the prioritized and lower-tier items are both presented in an intermingled ordered manner. The user can similarly revert to a priority only view by providing a layer-collapse user input (e.g., a pinch gesture), wherein the lower-tier items collapse into the bar visual representation.

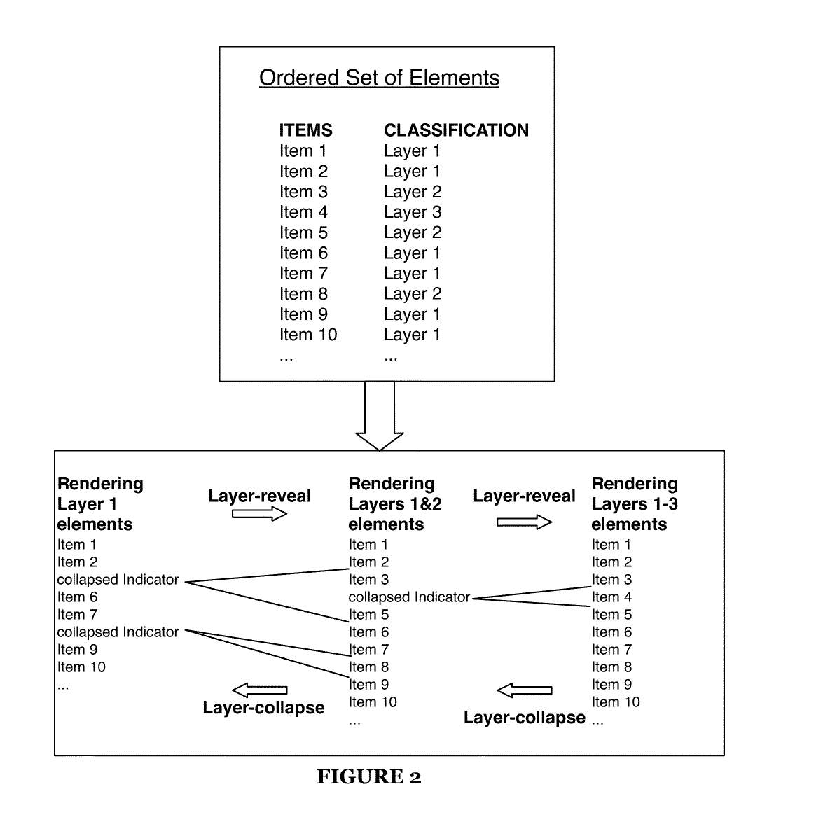

Multi-layered preferably describes the property of a set of data that can have multiple types, dimensions, categories, and/or levels of information. The layers of a set of information are preferably discrete in that an item can definitively be defined within one layer as shown in FIG. 2. For example, in a calendar event implementation, a first layer preferably includes personal calendar events, while a second layer includes events of followed or shared calendars. In another example, in a social media implementation, a first layer of a content stream can include posts from close friends within the social network, a second layer can include posts from distant friends on the social network, a third layer can include public posts of unconnected users within a nearby geographic region. The layers can additionally include an order or hierarchy such that the hierarchy of layers predefines expansion and collapse of layers in response to input. The layers may alternatively be approximated or defined within a continuous gradient of layers, wherein navigation of the layers can function as a progressive filtering of ordered information along a second dimension. For example, a time ordered scrollable list of items could additionally be gesturally zoomed/navigated according to geographic location, which could have continuous “layer” dimension across a dimension of distance from the user.

Block S110, which includes defining an ordered set of elements that include elements classified into multiple layers, functions to obtain, receiving, product or otherwise set the data set used in the interface. The elements in the ordered set preferably have at least one meta-data property that can be leveraged in the organization of the information. The elements are preferably classified into at least two layers. A first layer includes a first set of elements that is a subset of elements from the ordered set. An at least second layer of elements is similarly a subset of elements from the ordered set. There can additionally be any suitable number of layers. The set of elements for each respective layer is preferably a non-intersecting set of elements with the other layers—one element preferably belongs to a single layer. However, the elements as a collection within the ordered set preferably have a defined order. For example all the elements can have a timestamp that defines order within the ordered set. As described above, in one alternative, the layers can include a hierarchical layer structure wherein one element can be a descendent of a sequence of layer classifications. Herein, a two layer example is primarily used in describing but it would be appreciated that the methods and systems can be applied to multiple layers. A first layer includes a set of elements that are of a higher order classification than set of second layer elements. In a two layer example, the elements classified in the first layer can be a primary layer and may always be rendered within the scrollable view of the navigable interface. Correspondingly, elements of the second layer transition between a multi-layer rendering mode and a condensed indicator mode as described below.

The elements are preferably data objects or data associations that represent a programmatic model of some collection of information. Preferably the ordered set of elements is a time organized set of data such as calendar events, notifications, a news feed, a file system, a playlist, media collection, or any suitable set of data objects. The ordered set can alternatively be alphabetically ordered, a ranked set of information (e.g., search results), or any suitable ordered list. In an alternative variation, the ordered set may not have any pre-defined order but the collection could be arbitrarily ordered in the interface. The ordered set can additionally be sortable according to selectable properties. For example businesses could be ranked by rating, proximity, alphabetical, categories, and the like. An item in the ordered set is preferably a data entity representation. Properties, media, and other information related to the item can be associated with or stored with the item. For example, a calendar event in the ordered set can preferably access the name of the event, location of the event, time of the event, participants of the events, and any suitable event information.

As discussed above, within the ordered set there are preferably at least two layers of items. The layers can be a classification of the items. There are at least two but there can additionally be more. Defining an ordered set of elements can additionally include processing the ordered set into the two layers. Any suitable categorization, content identification, or filtering can be applied to segregating the items into at least one of two layers. The layers of items can be pre-defined, but alternatively, defining an ordered set with items of at least two layers can include classifying a set of items into at least two layers. The method can include a set of predefined or dynamic classification heuristics or algorithms to classifying the items of the data set into one of at least two layers.

In one variation, the ordered set of elements is a date organized list of events from multiple calendar classifications. The first layer elements are elements from a first calendar and elements of the second layer elements are elements from at least a second calendar. Any number of calendars can be organized/classified into any suitable number of layers. In one particular implementation elements of the at least second calendar are elements for a set of calendars that are selectively subscribed to by a user. The first layer elements are preferably elements from a set of user managed calendars. User managed calendars may include personally created calendars. Calendars synchronized to an account. Any suitable type calendars can be classified to any of the layers. As an example of a calendar event feed, the events are preferably segregated into a first layer if the event is an event from the user's personal calendar, and events are segregated into a second layer if the event is a shared calendar, a followed calendar, or other suitable calendar.

In another variation, the ordered set of elements is a feed of news items published by a set of users. This can include a news feed or stream from one or more social media platforms. The first and second layer of elements can be classified according to a type of social network connection of a user to the published of the news items. The type of social network connection can include a grouping and prioritization of social media contacts (e.g., family, close friends, co-workers, distant friends, etc.). The type of social network connection can additionally include geographic proximity to the location associated with the news item.

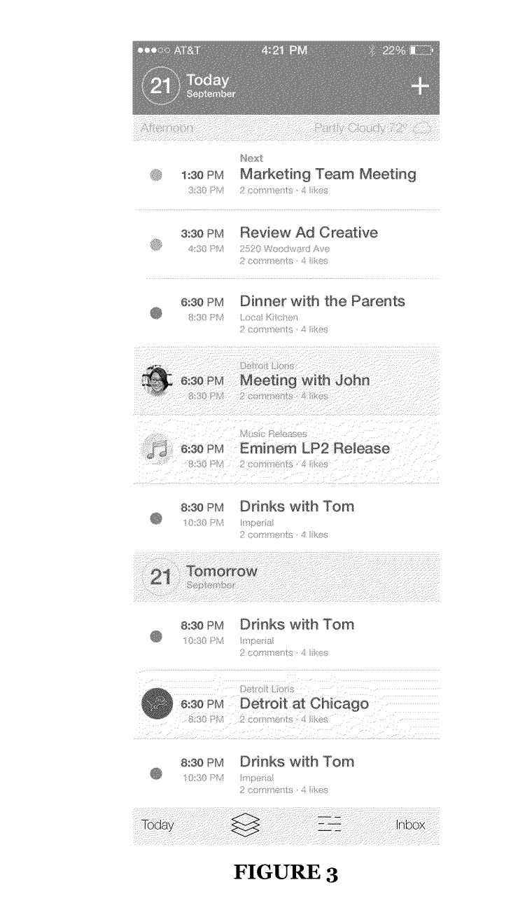

Block S120, which includes rendering a set of first layer elements of the ordered set in a navigable interface, functions to display or present the first layer items. The set of first layer elements are preferably ordered according to the ordered set. Rendering preferably includes displaying the items but in the case of multimedia items can additionally include playing or activating the items. More specifically, rendering can include displaying a structured graphical representation of at least a subset of data associated with the element. In the case where the elements can be interacted with by a user (e.g., selected to go to a detail view, favoriting, changing layer classification, etc.), rendering an element can additionally include activating user interaction detection of that element within the navigable interface. Activating user interaction can include registering touch events, or other event callbacks to map user input to actions performed in association with the element. The full set of items may not be fully presented at one time on the device, and will frequently rely on scrolling as a navigational mechanism for the navigation interface. For example, rendering will display and appropriately position the elements according the scroll position/scroll window of the navigable interface. The navigational interface can additionally use panning or another suitable navigation mechanism. A view controller or other suitable module can manage or facilitate the asset loading and deprecation of items as the user navigates away from the items (e.g., the item scrolls off the screen). The navigable interface is preferably a scrollable view of stacks of items along a first axis. The navigable interface can alternatively be a gallery, coverflow, waterfall, or grid representation of items. Multiple layers can additionally be present within the navigable interface depending on the current layer state. As shown in FIG. 3, items of different layers can have a different presentation style such as the background being a different color.

Block S130, which includes rendering a condensed indicator element associated with at least one element classified in a second layer in the navigable interface, functions to incorporate a perceptible cue of presence of items from a different layer. The condensed indicator element is ordered within the set of first layer elements according to the ordered set. The condensed indicator and rendered elements are preferably displayed in an intermingled manner according to their order. The condensed indicator element is preferably associated with a set of elements not in the first layer. There can multiple condensed indicator elements. And a single condensed indicator element can be associated with one or more elements of the second and/or additional layers.

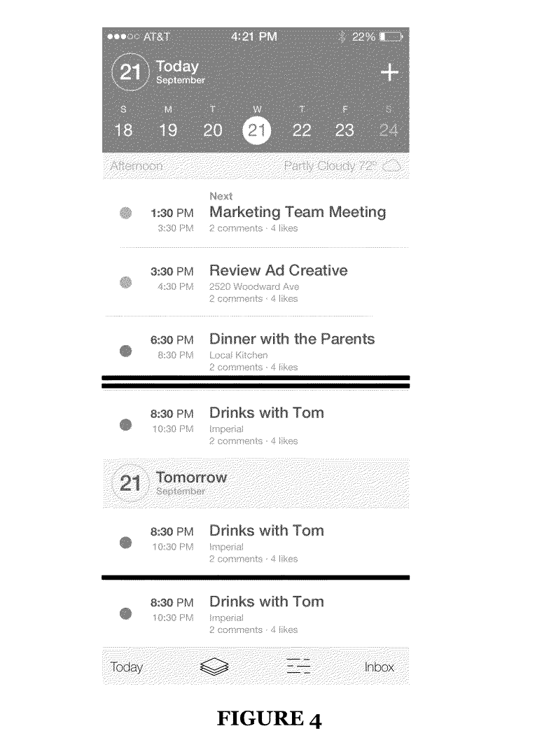

The condensed indicator is preferably a graphical bar or divider presented between items of the first layer in which the second layer items would be present if the first and second layer items were rendered together in a multi-layer mode as shown in FIG. 4. The condensed indicator element can be used to indicate presence of at least one hidden element, but may additionally be used to communicate additional information about the associated element(s). In one variation, the condensed indicator element is rendered with a graphical property associated with the layer classification of the associated elements. In a calendar example, red condensed indicator may be used to indicate the hidden element is a sports calendar event, and a blue condensed indicator may be used to indicate the hidden element is a movie calendar event. In another variation, the condensed indicator element is rendered with a unique graphical property associated with the number of associated elements. Graphical properties of the indicator such as color, patterns, dimensions, and other properties can additionally be used to signal the type of content, the amount of second layer content, the number of hidden items, and other suitable properties of the items from the other items. In one variation, the condensed indicator is represented as a simulated gap, break, or exposure to a layer beneath the currently represented items. A condensed indicator is preferably present inline with the items of the first layer wherever a hidden layer item would have been present. When multiple items of a second layer would be present in a particular index then multiple condensed indicators can be displayed. Alternatively, a single condensed indicator can be used. The single condensed indicator may use graphical dimensions, patterning, or other properties to communicate the number or scale of associated elements. The condensed indicators can be for items from any suitable layer below the current displayed layer. As mentioned above, layers can have an order. Items from a sub-layer (i.e., a layer of less preference) can be hidden and represented by a condensed indicator. The representation of the condensed indicator can correspond to the “distance” or number of gestures required to display the item. For example, a proximate hidden layer may have a thicker bar, but a hidden layer that requires multiple “revealing” gestures before being revealed could be represented as a thin bar. When implementing the view controller module, the actual content of the items of the second layer are preferably not loaded or allocated to memory until necessitated by a corresponding gesture of the user (e.g., as in S140). In one variation, the first layer items have momentum when scrolling through in the navigable interface. For example, scrolling through the list can result in spacing between the items to increase which functions to simulate momentum of the items. Representing a condensed indicator can additionally include expanding the indicator and revealing item content. For example, the condensed indicator in the navigable interface can be configured to act as a gap in the first layer; when scrolling the gap increases to reveal a portion of item content.

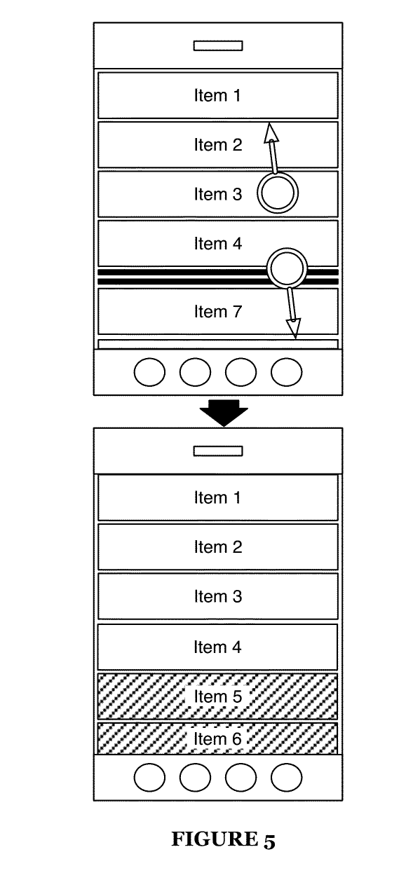

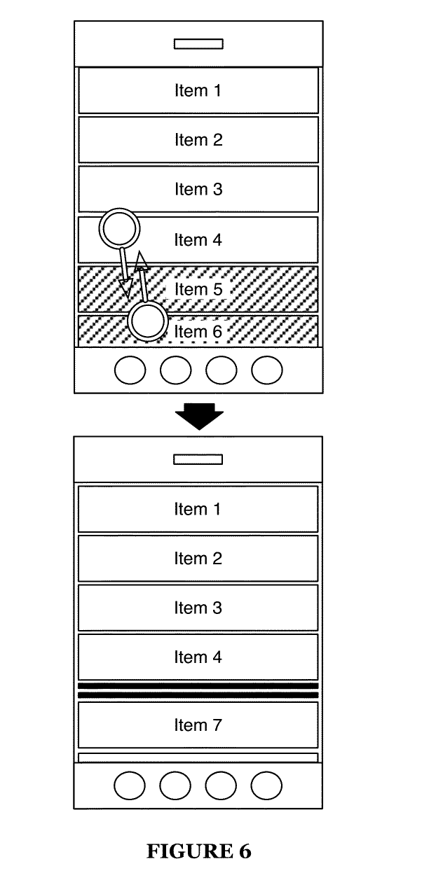

Block S140, which includes receiving a user input, functions to detect a gesture or other directive that corresponds to navigation of the items of the ordered set. The user input is received at the navigable interface, and in a gesture-based interface, the user input can be gesture. The user input may alternatively be any suitable form of user input such as button activation, voice command, mouse action, or other suitable type of input. The gesture is preferably a multi-touch input that includes detecting multiple touch points changing in their relative distance. There are preferably at least two varieties of gestures detected: a layer-reveal gesture and a layer-collapse gesture. The layer-reveal gesture can be two or more touch inputs that spread apart as shown in FIG. 5. The layer-collapse gesture can be two or more touch inputs coming closer together as shown in FIG. 6. In one variation, the relative change in distance can be measured along a single axis, and more preferably measured along the scrolling axis. As an example, the change in distance between at least two points is measured along a vertical axis for a list of elements and condensed indicator elements. The input gesture can additionally have a magnitude or value relative to its current state such that augmenting presentation of the layers can be progressively, incrementally, or gradually altered to map to the magnitude of the gesture to the continuous reveal or collapse of a layer from the navigational interface. In one variation, the magnitude of the gesture determines the number of layers transitioned between a multi-layered mode and a condensed indicator mode. The user input may alternatively result in a discrete change in layer presentation. In place of a pinching or spreading gesture, the gesture could be a multi-point swipe, a multi-point circular motion, a tapping pattern, a tilting of the device, a shaking motion, performing set gestures with a designated number of fingers/touch points, or any suitable detectable user input.

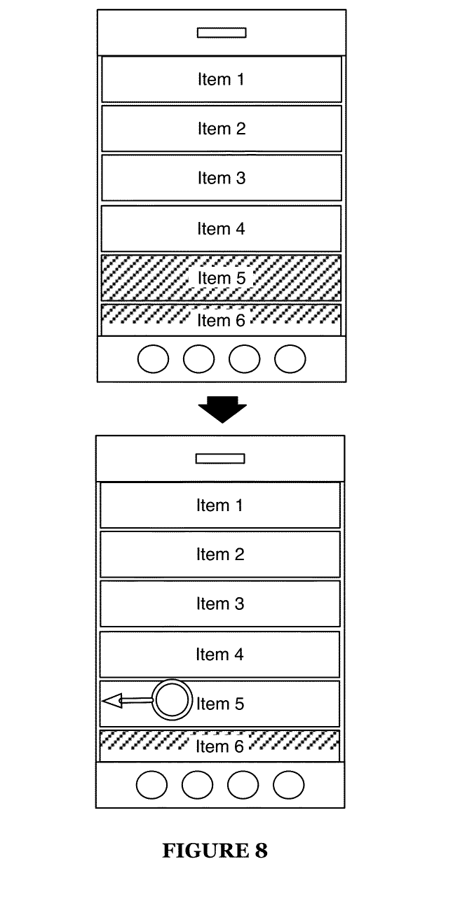

Additional forms of user input of the navigable interface include receiving a scrolling input. Scrolling input preferably results in scrolling the rendered elements in the navigable interface as would be appreciated by one knowledgeable in the art. Scrolling preferably occurs along a single axis. The navigable interface can be substantially represented as a scrollable list where the elements and the condensed indicator elements are ordered according at least one parameter. The navigable interface can additionally include two or more dimensional scrolling, which may scroll elements in at least two directions. The scrolling input is preferably a swiping motion. Additionally, receiving a user input can include receiving a classification change input. One or more selected elements and/or condensed indicators can be reclassified into a different layer. Reclassifying a layer can act to promote or demote an element. Correspondingly, a classification change input is preferably accompanied by updating classification of at least one re-classified element within the ordered set and rendering the re-classified element according to the current layer classification as shown in FIGS. 8, 9, and 12. The classification change input is preferably a button activation event. For example, a second layer element can include a button when rendered in a multi-layer mode. The button can act to promote a rendered element to the first layer elements. In the two layer variation, promoting a second layer element acts to make that particular element available for rendering along with the other first layer elements (depending on the scroll position within the navigable interface). The button can similarly demote an element and make it transition to a condensed indicator element in response to a layer-collapse input. Other suitable user inputs can similarly be detected and acted upon.

Detection of a user input may additionally be dependent on the rendering mode of the layers of an ordered set. The navigable interface preferably monitors for a layer-reveal input when at least one element of a layer is in a condensed indicator mode. The layer-reveal input may not be detected when there are no condensed indicators. Alternatively, a user interface feedback event may be triggered if a layer-reveal input is applied when there are no items to reveal. The navigable interface may apply a spring like effect, make a sound, animate some transformation of the screen, or apply any suitable feedback. Similarly, an action can be triggered if no elements can be transitioned between rendering mode. The navigable interface preferably monitors for a layer collapse input when at least one element of a layer is being rendered but is eligible to be transitioned to a condensed indicator. Feedback and event triggering can similarly be associated with performing a layer-collapse input when there are no elements for transitioning to a condensed indicator element.

Block S150, which includes augmenting a layered representation of the ordered set of information in the navigable interface, functions to change the layers presented in the navigable interface. The layered representation changes the presentation of elements and condensed indicator elements wherein the layered representation is augmented in accordance with the user input. In a first state of the navigable interface, if the gesture is a layer-reveal input (e.g., two finger spreading gesture), augmenting the layered representation of the navigable interface includes transitioning at least an element of the second layer to a multi-layer rendering mode in response to the layer-reveal user input, which functions to present elements of at least the second layer of the ordered set in the navigable interface ordered according to the set. The method will additionally include, while in the multi-layer rendering mode, rendering the at least one element classified in the second layer in the navigable interface. The elements are preferably revealed as emerging from a corresponding condensed indicator. When multiple layers are concurrently presented in the navigable interface, the items can be color-coded or otherwise indicated as belonging to different layers. The layer-reveal gesture input can be repeatedly performed to bring the next layer of items into the view. If all layers have been revealed and the layer-reveal gesture is performed, the displayed items can be animated to indicate all items are presented. For example, the items can spread apart and then spring back to their original position when a layer-reveal gesture input is detected when all the layers are displayed.

In a second state of the navigable interface, if the gesture is a layer-collapse input (e.g., two finger pinching inward gesture), augmenting the layered representation of the navigable interface includes transitioning at least one element of the second layer to a condensed indicator mode in response to the layer-collapse user input, which functions to remove items of at least the second layer from presentation in the navigable interface. The method will additionally include, while in the condensed indicator mode, rendering the condensed indicator element in the navigable interface, wherein the condensed indicator element is associated with the at least one element classified in a second layer. The items are preferably collapsed or animated as transforming into a condensed indicator. Collapsing is preferably possible when there are two or more layers concurrently displayed. In the interface. The layer-collapse gesture can be repeatedly performed to incrementally remove items of the next layer from presentation. If only a single layer is displayed in the navigable interface, the layer-collapse gesture can navigate the user to another user interface view such as the previous screen, a home screen, a status page, or any suitable view. Alternatively, if only a single layer is displayed in the navigable interface, the layer-collapse gesture can result in an animation indicating the navigable interface is fully collapsed. For example, the items can pinch together and then spring back to original position after the layer-collapse gesture is completed.

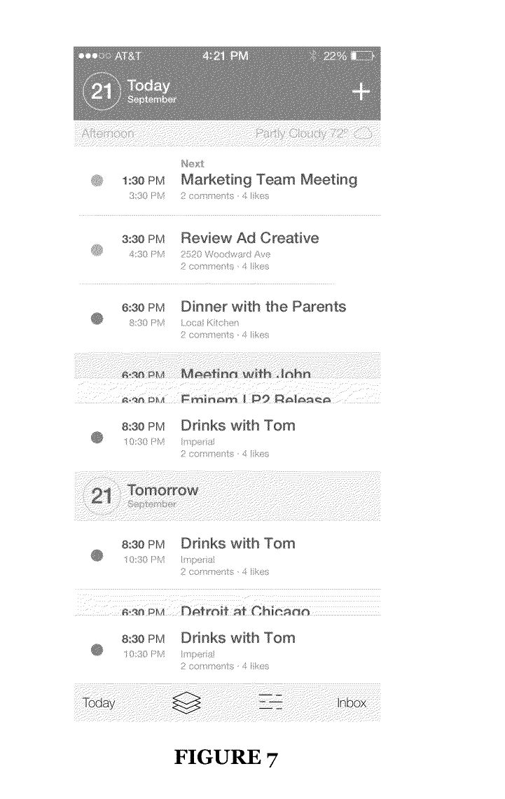

The augmenting presentation of the layers can additionally include animating either change in presentation of a layer within the navigable interface. More specifically this can include rendering an animated transition of the collapsed indicator element into at least one associated element. The animated transition preferably shows a collapsed indicator element expanding into one or more elements or showing one or more elements collapsing into a collapsed indicator element. This can additionally include mapping the animation state to the magnitude of at least one dimension of the user input. As shown in FIG. 7, animating can cause a layer to be partially presented in the navigable interface. In a preferred implementation, the condensed indicators are treated as an opening and closing gap from which items can be revealed or to which items can be concealed. Any suitable simulated animation can alternatively be used. In both states the relationship of an element to a collapsed indicator element can be one to one or many to one. The elements may all be from the same layer or from multiple layers. Accordingly rendering an animated transition of the collapsed indicator element into at least one associated element can include rendering an animated transition of the collapsed indicator element into a plurality of associated elements. Preferably, one collapsed indicator element is used for a subset of elements that are hidden from a presented layer but are consecutive in the ordered set.

Additionally, the augmenting the layered representation of the ordered set can include applying a rendering mode transition to a selected element, which functions to transition the rendering mode of one or a subset of elements within a layer. The element is preferably selected by associating a user input to a select number of elements. More specifically, the method include detecting the layer-reveal input in association with a first condensed indicator element; and expanding the first condensed indicator independently from at least a second condensed indicator element. Similarly, the method can include detecting the layer-collapse input in association with a first element of the second layer and collapsing the first element of the second layer into a condensed indicator independently from at least a second element of the second layer. Alternatively, one user input is applied to all similar elements. For example, a layer-reveal input reveals all elements at least in the next layer. Similarly, a layer-collapse input can collapse all elements of the lowest layer elements currently rendered.

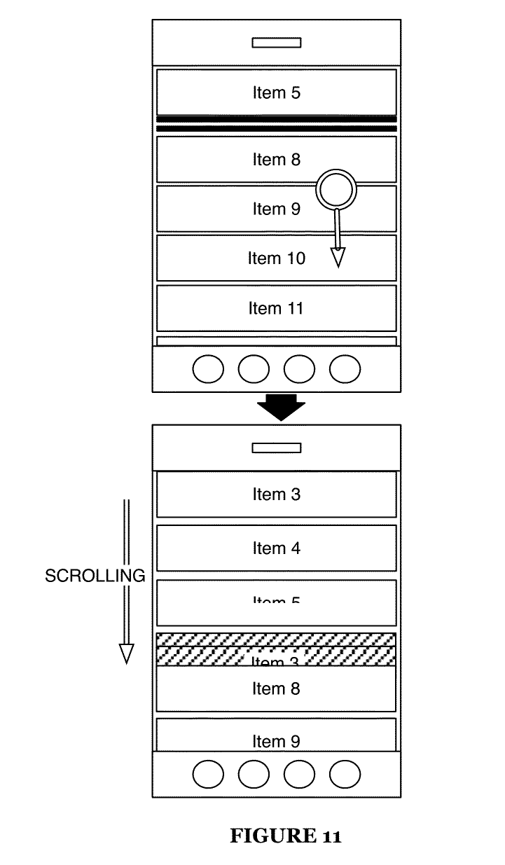

As an additional alternative, the method can include augmenting ordered set in response to a scrolling wherein scrolling the rendered elements of the ordered set includes rendering an expansion of a condensed indicator element into an at least partial rendering of an element during active scrolling as shown in FIG. 11. This variation preferably animates the hidden elements being revealed as if appear between gaps that appear as a result of scrolling. The reveal of hidden elements can integrate a momentum based scrolling effect that results in revealing of hidden layered elements.

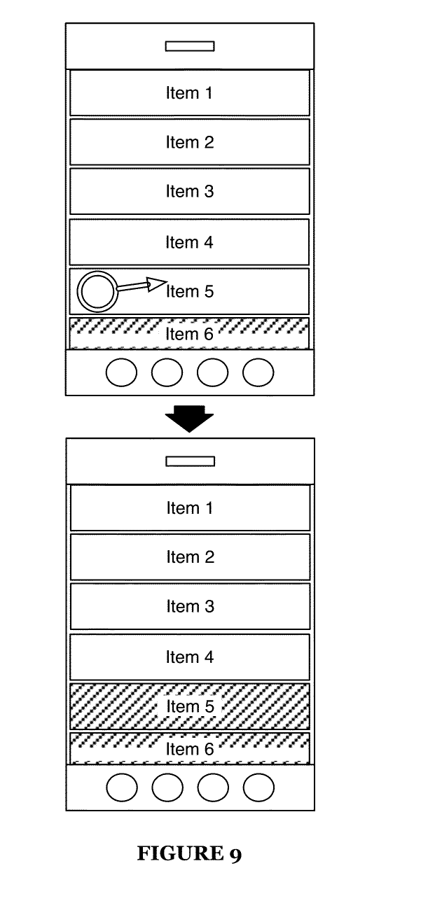

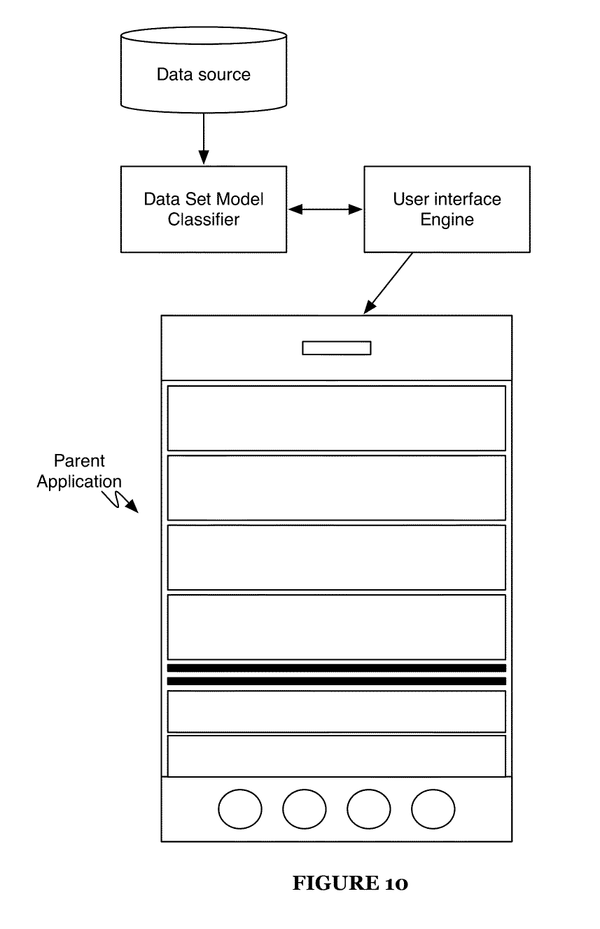

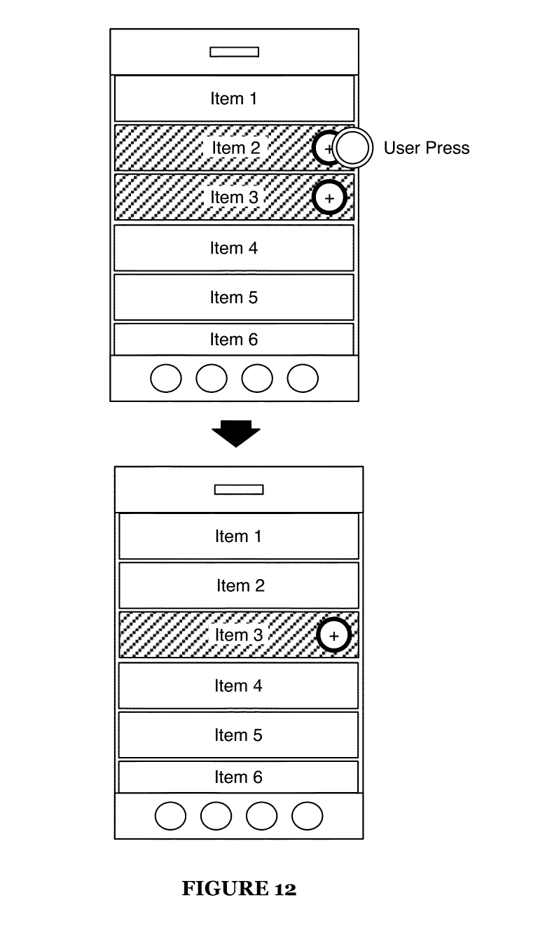

Additionally, the method can include migrating an item to a new layer. A user can promote an item to another layer as shown in FIG. 8 or demote an item to another layer as shown in FIG. 9. The method will preferably include receiving a classification change input, then updating classification of at least one re-classified element within the ordered set, and rendering the re-classified element according to the current layer classification. In one variation an element-promotion input promotes an element to the next highest layer (e.g., promoting from second layer to first layer). In another variation, an element-demotion input demotes an element to the next lowest layer (e.g., demoting from first layer to second layer). The element-promotion and element-demotion inputs can be applied directly to a selected element, but may alternatively be applied to a subset of elements. The element-promotion and element demotion inputs can be swiping gesture inputs, which are preferably detected as swipes substantially perpendicular to direction of scrolling. Alternatively, a button may be used as shown in FIG. 12. Additionally, the classification of items can use user actions to automatically identify similar items. In general use the first layer is preferably used for items of the highest priority that a user should see first, and other layers are used for lesser priority, which a user may optionally explore. An item is preferably marked or signaled to be moved to another layer in response to a user input. The user input can be activation of a button, a gesture input directed at the item. A single item can be moved to a layer or alternatively a group of items can be moved at one time. In one implementation, a swiping motion applied to the item can indicate the promotion or demotion of the item to a higher or lower layer. In addition to moving another layer, the item can be moved to another layer conditional on a first condition. The condition can be a time condition, item property condition, user location condition, and/or any suitable condition. For example, an item can be demoted from a first layer to a second layer conditional on a timeout period. When the timeout period expires, the item can be automatically promoted to the first layer.

In one preferred implementation, the method can be applied within a calendar application. The calendar application can allow management of a personal calendar as well as shared or followed calendars. Within the calendar, there is preferably at least one portion of the application that is a scrollable list of calendar events. The events can be for a particular day, month, year, or all time. The set of data used is preferably the time ordered list of calendar events from all relevant calendars. The personal calendar is preferably includes high priority events and are classified within a first layer. The application can additionally enable a user to configure any calendar or type of events to similarly be classified as a first layer. Followed calendars and/or calendars shared by acquaintances can be classified in a secondary layer. When scrolling through the list of events, a user is initially presented with the events of the first layer. The user can identify when a hidden event is present between different events. When the user wants to check on a secondary event, the second layer events are revealed in response to a gesture. The items of the second layer are brought into the list ordered within the first layer. After the user has confirmed information from the second layer items, the user can collapse the events to a condensed indicator.

In a second preferred implementation, the method can be applied within a social media application. The social media application preferably includes a content feed of posts from the user, posts from other connected users of the social media network, and/or promoted content within the social media network. The posts in the content feed of a user preferably form the set of data used in the method. All the posts considered for display in the content feed could be perceived by the user as an overwhelming amount of information. The method can enable posts to be automatically categorized into two or more priority levels. The user can then employ the gesture input of the method to expand or restrict the amount and type of information displayed. Similarly, the user can use promotion/demotion gestures to tailor the content feed. The promotion/demotion gestures can be tied to social media actions such as liking, voting up, voting down, commenting, and other suitable interactions with a post.

### 2. System for Presenting a Multi-Layered Ordered Set

A system for presenting a responsive multi-layered ordered set of information of a preferred embodiment can include a parent application, a data set model classifier, and a user interface engine. The system functions to provide an intuitive and non-intrusive user interface for parsing, filtering, and digesting large amounts of information. The system is preferably used so that a user can reveal or collapse items within an ordered scrollable list. As opposed to requiring navigating between different sets of data or manually activating filtering options (which can require screen real-estate consuming buttons and/or greater cognitive load), the system simulates an intuitive data navigation interface in which items are represented in a condensed form until being expanded within the original context. The system is preferably used on a touch sensitive computing device or a device with a gestural input component, but the system can similarly be integrated into a traditional computing device such as a keyboard and mouse desktop computer or any suitable computing device.

The parent application of the preferred embodiment functions to integrate and use a user interface view that employs the use of the data set model classifier and user interface engine. The parent application can be any suitable type of application. The parent application will preferably include a requirement to present a scrollable list of digital content that can be filtered or classified into at least two classifications or layers. The digital content can be a view of a data object such as a calendar event, a user post, a product listing, a news story, historical record, an image thumbnail, an email, a video, a media representation, and/or any suitable type of digital content.

The data set model classifier of the preferred embodiment functions to manage the set of data that supports or supplies the user interface engine with content. The data set model classifier preferably manages an ordered set of data. The items of the set of data can be classified within one of two or more different layers. Any suitable categorization, content identification, or filtering can be applied to segregating the items into at least one of two layers. For a calendar event feed, the events are preferably segregated into a first layer if the event is an event from the user's personal calendar, and events are segregated into a second layer if the event is a shared calendar, a followed calendar, or other suitable calendar. The layers of items can be pre-defined, but alternatively, defining an ordered set with items of at least two layers can include classifying a set of items into at least two layers. The method can include a set of predefined or dynamic classification heuristics or algorithms that output a classification of the items of the data set into one of at least two layers. The layers can additionally include an order or hierarchy such that the layering of classified items predefines expansion and collapse of layers in response to input. There can be two distinct layers, three layers, or any suitable number of layers. The layers may alternatively be approximated or defined within a continuous gradient of layers, wherein navigation of the layers can function as a progressive filtering of ordered information along a second dimension. For example, a time ordered scrollable list of items can additionally be gesturally zoomed/navigated according to geographic location, which could have continuous “layer” dimension across a dimension of distance from the user. The data set modeler classifier can preferably manage meta-data that maintains the layer status of an object. The data set modeler classifier can work on a data set substantially stored external to the module or application. Alternatively, the full data set can be stored within a database managed by the data set modeler classifier

The user interface engine of the preferred embodiment functions to manage user interactions and presentation of data objects within the user scrollable layered view. The user interface engine can manage the loading, fetching, rendering, allocation, and other suitable forms of management used in presenting the items of the data set. Additionally the user interface engine can manage user inputs and translate interactions to manipulations and control signaling to the data set modeler classifier. The user interface engine preferably represents each item of the set of data either as a rendered object view of the item or a condensed indicator. A rendered object view is a presentation that displays content associated with the item. For example, a calendar event object view can include a calendar name, event name, and event details. A condensed indicator is preferably graphical indicator of the position of an associated item. The graphical indicator is preferably a bar or horizontal divider. Content related to the item is preferably not reflected in the condensed indicator. In one variation, however, the color can be used to indicate a classification or labeling of the associated event. For example, social related events can be one color, where business meeting events are another color. Additionally, multiple events can be represented by a single condensed indicator if their location is between the same higher layer items. The thickness of the divider can be proportional to the number of associated hidden items.

The user interface engine additionally is registered as a delegate or a receiver of user input. The user interface engine can map particular user input actions or patterns of input to particular actions. The user interface engine can preferably detect a revealing input and a collapsing input, which are used to control adding of the next layer to presentation or removing a layer from presentation. Additionally, the user interface engine can detect promotion and demotion inputs that can be applied to one or more item to change the layer classification.

The system and methods of the preferred embodiment and variations thereof can be embodied and/or implemented at least in part as a machine configured to receive a computer-readable medium storing computer-readable instructions. The instructions are preferably executed by computer-executable components preferably integrated with the user interface system. The computer-readable medium can be stored on any suitable computer-readable media such as RAMs, ROMs, flash memory, EEPROMs, optical devices (CD or DVD), hard drives, floppy drives, or any suitable device. The computer-executable component is preferably a general or application specific processor, but any suitable dedicated hardware or hardware/firmware combination device can alternatively or additionally execute the instructions.

As a person skilled in the art will recognize from the previous detailed description and from the figures and claims, modifications and changes can be made to the preferred embodiments of the invention without departing from the scope of this invention defined in the following claims.

What is claimed is:

1. A method for presenting a scrollable-list interface comprising:
defining an ordered set of elements which includes elements classified into at least two layers;
rendering a set of first layer elements of the ordered set in a navigable interface, the set of first layer elements ordered according to the ordered set;
rendering a condensed indicator element associated with at least one element classified in a second layer in the navigable interface, the condensed indicator element ordered within the set of first layer elements according to the ordered set;
receiving a user input to the navigable interface; and
augmenting a layered representation of the ordered set in the navigable interface, wherein the layered representation is augmented in accordance with the user input.

2. The method of claim 1, wherein receiving a user input to the navigable interface comprises receiving a layer-reveal user input; wherein augmenting a layered representation of the ordered set comprises transitioning at least an element of the second layer to a multi-layer rendering mode in response to the layer-reveal user input; and further comprising, while in the multi-layer rendering mode, rendering the at least one element classified in the second layer in the navigable interface.

3. The method of claim 2, wherein receiving a user input to the navigable interface comprises receiving a layer-collapse user input while in a multi-layer rendering mode; and wherein augmenting the layered representation of the ordered set comprises transitioning at least one element of the second layer to a condensed indicator mode in response to the layer-collapse user input; wherein, while in the condensed indicator mode, rendering the condensed indicator element in the navigable interface, wherein the condensed indicator element is associated with the at least one element classified in a second layer.

4. The method of claim 3, wherein defining an the ordered set of elements, wherein the set ordered set of elements further includes elements classified into at least a third layer; and wherein while an element of the second layer is in a multi-layer rendering mode, rendering at least a second condensed indicator element in the navigable interface, wherein the second condensed indicator element is associated with at least one element classified in a third layer.

5. The method of claim 4, wherein while an element of the second layer is in a multi-layer rendering mode, transitioning at least an element of the third layer to a multi-layer rendering mode in response to a second layer-reveal user input.

6. The method of claim 3, further comprising detecting the layer-reveal input in association with a first condensed indicator element; and expanding the first condensed indicator independently from at least a second condensed indicator element.

7. The method of claim 3, wherein all condensed indicator elements of the second layer are expanded upon receiving the layer-reveal input

8. The method of claim 3, wherein receiving a user input to the navigable interface comprises receiving a scrolling input; and wherein augmenting the layered representation of the ordered set comprises scrolling rendered elements in the navigable interface.

9. The method of 8, wherein layer-reveal input is a multi-touch spreading gesture, wherein the layer-collapse gesture is a multi-touch pinching gesture.

10. The method of claim 8, wherein transitioning at least the second layer to a condensed indicator mode comprises rendering an animated transition of the element collapsing into the collapsed indicator element; and wherein transitioning at least an element of the second layer to a multi-layer rendering mode comprises rendering an animated transition of the collapsed indicator element into at least one associated element.

11. method of claim 8, wherein rendering an animated transition of the collapsed indicator element into at least one associated element comprises rendering an animated transition of the collapsed indicator element into a plurality of associated elements.

12. The method of 8, wherein scrolling the rendered elements of the ordered set comprises rendering an expansion of the condensed indicator element into an at least partial rendering of the element during active scrolling.

13. The method of 8, wherein the layer-collapse gesture and layer-reveal gesture have a magnitude, and wherein the magnitude of the gesture determines the number of layers transitioned between a multi-layered mode and a condensed indicator mode.

14. The method of claim 1, wherein the condensed indicator element is associated with a set of elements not in the first layer.

15. The method of claim 1, further comprising receiving an classification change input; updating classification of at least one re-classified element within the ordered set; and rendering the re-classified element according to the current layer classification.

16. The method of claim 1, wherein the ordered set of elements is a date organized list of events from multiple calendar classifications; wherein the first layer elements are elements from a first calendar and elements of the second layer elements are elements from at least a second calendar.

17. The method of claim 16, wherein the elements of the at least second calendar are elements from a set of calendars selectively subscribed to by a user, and first layer elements are elements from a set of user managed calendars.

18. The method of claim 1, wherein the ordered set of elements is a feed of news items published by a set of publishers, and wherein the first and at least second layer of elements are classified according to a type of social network connection of a user to the publisher of a news item.

19. The method of claim 1, wherein rendering an element comprises displaying a structured graphical representation of at least a subset of data associated with the element and activating user interaction detection of that element within the navigable interface.

20. The method of claim 1, wherein the condensed indicator element is rendered with a graphical property associated with the layer classification of the associated elements.

21. The method of claim 1, wherein the condensed indicator element is rendered with a unique graphical property associated with the number of associated elements.
